(19) United States
(12) Patent Application Publication
(10) Pub. No.: US 2011/0257330 A1
(43) Pub. Date: Oct. 20, 2011

(54) WATERBORNE COATING COMPOSITION CONTAINING POLYTRIMETHYLENE ETHER DIOL

(75) Inventors: Ayumu Yokoyama, Wallingsford, PA (US); Sheau-Hwa Ma, West Chester, PA (US); Rajesh Gopalan Saliya, Media, PA (US)

(73) Assignee: E.I. DU PONT DE NEMOURS AND COMPANY, Wilmington, DE (US)

(21) Appl. No.: 13/141,989

(22) PCT Filed: Dec. 28, 2009
(86) PCT No.: PCT/US09/69561

§ 371 Date: Jun. 24, 2011

Related U.S. Application Data
(60) Provisional application No. 61/141,259, filed on Dec. 30, 2008.

(51) Int. Cl. C09D 133/02; C09D 167/04; B05D 3/00

(52) U.S. Cl. 524/558; 427/385.5; 524/599

(57) ABSTRACT

The present invention is directed to an aqueous coating composition comprising a polymer having one or more crosslinkable functional groups; a polytrimethylene ether diol from renewable resource having a Mn (number average molecular weight) in a range of from 500 to 10,000; and a crosslinking agent. The aqueous coating composition comprises in a range of from 10% to 80% of water.

### CROSS-REFERENCE TO RELATED APPLICATION

This application claims priority from U.S. Provisional Application Ser. Nos. 61/141,259, 61/141,262, 61/141,263, and 61/141,264 (all filed Dec. 30, 2008), the disclosure of which is incorporated by reference herein for all purposes as if fully set forth.

### FIELD OF INVENTION

The present invention is directed to an aqueous coating composition. This invention is particularly directed to an aqueous coating composition comprising components derived from renewable resources.

### BACKGROUND OF INVENTION

Surface coatings over a substrate can be used for the protection and decoration of the substrate such as vehicle bodies, machineries, instruments, or other articles. A typical surface coating over a substrate can comprise some or all of the following layers: (1) one or more primer layers that provide adhesion and basic protection, such as corrosion protection; (2) one or more colored layers, typically pigmented, that provide most of the protection, durability and color; and (3) one or more clearcoat layers that provide additional durability and improved appearance. A colored topcoat layer can be used in place of the colored layer and the clearcoat layer. Each of the coating layers can be produced from one or more coating compositions.

In order to reduce the emission of volatile organic compounds (VOC) to the environment, water based paints, also known as aqueous coating compositions or waterborne coating compositions are increasingly used in automotive and industrial coatings. An aqueous coating composition typically contains one or more polymers such as acrylate or methacrylate polymers, typically having ionic groups or non-ionic groups that impart water compatibility, dissolved or dispersed in an aqueous solution, such as water. Examples of aqueous coating compositions can include those described in U.S. Pat. No. 7,091,278 or U.S. Pat. No. 5,314,945.

To further improve coating properties, there is a continued need for advanced aqueous coating compositions.

### STATEMENT OF INVENTION

This invention is directed to an aqueous coating composition comprising:
A) a polymer dissolved or dispersed in water, said polymer comprises one or more crosslinkable functional groups;
B) a polytrimethylene ether diol having a Mn (number average molecular weight) in a range of from 500 to 10,000; and
C) a crosslinking agent having one or more crosslinking functional groups;
wherein said aqueous coating composition comprises in a range of from 10% to 80% of water, percentage based on total weight of the aqueous coating composition.

This invention is also directed to a process for coating a substrate to form a coating layer thereon, said process comprising the steps of:
a) providing an aqueous coating composition comprising:
   A) a polymer dissolved or dispersed in water, said polymer comprises one or more crosslinkable functional groups;
   B) a polytrimethylene ether diol having a Mn (number average molecular weight) in a range of from 500 to 10,000; and
   C) a crosslinking agent having one or more crosslinking functional groups;
   wherein said aqueous coating composition comprises in a range of from 10% to 80% of water, percentage based on total weight of the aqueous coating composition;
b) applying said aqueous coating composition over the substrate to form a layer of said aqueous coating composition thereon; and
c) curing said layer of the aqueous coating composition to form said coating layer

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “(meth)acrylate” means methacrylate or acrylate.

The term “two-pack coating composition”, also known as 2K coating composition, refers to a coating composition having two packages that are stored in separate containers and sealed to increase the shelf life of the coating composition during storage. The two packages are mixed just prior to use to form a pot mix, which has a limited pot life, typically ranging from a few minutes (15 minutes to 45 minutes) to a few hours (4 hours to 8 hours). The pot mix is then applied as a layer of a desired thickness on a substrate surface, such as an automobile body. After application, the layer dries and cures at ambient or at elevated temperatures to form a coating on the substrate surface having desired coating properties, such as, high gloss, mar-resistance and resistance to environmental etching.

The term “crosslinkable component” refers to a component having “crosslinkable functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with crosslinking functional groups (during the curing step) to produce a coating in the form of crosslinked structures. One of ordinary skill in the art would recognize that certain crosslinkable functional group combinations would be excluded, since, if present, these combinations would crosslink among themselves (self-crosslink), thereby destroying their ability to crosslink with the crosslinking functional groups. A workable combination of crosslinkable functional groups refers to the combinations of crosslinkable functional groups that can be used in coating applications excluding those combinations that would self-crosslink.

Typical crosslinkable functional groups can include hydroxyl, thiol, isocyanate, thioisocyanate, acid or polyacid, acetoacetoxy, carboxyl, primary amine, secondary amine, epoxy, anhydride, ketimine, aldimine, or a workable combination thereof. Some other functional groups such as orthoester, orthocarbonate, or cyclic amide that can generate hydroxyl or amine groups once the ring structure is opened can also be suitable as crosslinkable functional groups.

The term “crosslinking component” refers to a component having “crosslinking functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable functional groups (during the curing step) to produce a coating in the form of crosslinked structures. One of ordinary skill in the art would recognize that certain crosslinking functional group combinations would be excluded, since, if present, these combinations would crosslink among themselves (self-crosslink), thereby destroying their ability to crosslink with the crosslinkable functional groups. A workable combination of crosslinking functional groups refers to the combinations of crosslinking functional groups that can be used in coating applications excluding those combinations that would self-crosslink. One of ordinary skill in the art would recognize that certain combinations of crosslinking functional group and crosslinkable functional groups would be excluded, since they would fail to crosslink and produce the film forming crosslinked structures. The crosslinking component can comprise one or more crosslinking agents that have the crosslinking functional groups.

Typical crosslinking functional groups can include hydroxyl, thiol, isocyanate, thioisocyanate, acid or polyacid, acetoacetoxy, carboxyl, primary amine, secondary amine, epoxy, anhydride, ketimine, aldimine, orthoester, orthocarbonate, cyclic amide or a workable combination thereof.

It would be clear to one of ordinary skill in the art that certain crosslinking functional groups crosslink with certain crosslinkable functional groups. Examples of paired combinations of crosslinkable and crosslinking functional groups can include: (1) ketimine functional groups generally crosslink with acetoacetoxy, epoxy, or anhydride functional groups; (2) isocyanate, thioisocyanate and melamine functional groups generally crosslink with hydroxyl, thiol, primary and secondary amine, ketimine, or aldimine functional groups; (3) epoxy functional groups generally crosslink with carboxyl, primary and secondary amine, ketimine, or anhydride functional groups; (4) amine functional groups generally crosslink with acetoacetoxy functional groups; (5) polyacid functional groups generally crosslink with epoxy or isocyanate functional groups; (6) anhydride functional groups generally crosslink with epoxy and ketimine functional groups; and (7) hydroxyl functional groups also crosslink with acetoacetoxy functional groups.

“Gloss” means surface gloss of a coating surface and is related to the amount of incident light that is reflected at certain reflectance angles of the mean of that surface. Gloss can be measured with a specular glossmeter, such as those available from Byk-Gardener, Geretsried, Germany.

The term “vehicle”, “automotive”, “automobile”, “automotive vehicle”, or “automobile vehicle” refers to an automobile such as car, van, mini van, bus, SUV (sports utility vehicle); truck; semi truck; tractor; motorcycle; trailer; ATV (all terrain vehicle); pickup truck; heavy duty mover, such as, bulldozer, mobile crane and earth mover; airplanes; boats; ships; and other modes of transport.

A substrate suitable for this invention can be a plastic, bare metal such as cold rolled steel, aluminum or other metal or alloys. One example of the cold rolled steel can be the one available from East Coast Steel Inc, Columbia, S.C. 29290, USA. The substrate can also be plastic or metal substrates with one or more existing coating layers. One example can be a steel substrate coated with an eletrocoat (e-coat) layer. Another example can be a steel substrate coated with an eletrocoat (e-coat) layer and a primer layer. Yet another example can be a steel substrate coated with a primer layer. Yet another example can be a steel substrate coated with a primer layer and a colored coating layer. The primer layer can be produced with an epoxy primer, an acrylic primer, a polyester primer, or other primers known to those of ordinary skill in the art. An epoxy primer means a primer composition comprises at least one epoxy resin or its derivatives. An acrylic primer means a primer composition comprises at least one acrylic resin or its derivatives. A polyester primer means a primer composition comprises polyesters or polyester derivatives. Other examples of substrate can include industrial equipments, pipes, structures, tanks, machines, amusement park equipments, concrete, woods, or any articles that are made from metals, plastics or composite materials.

This invention is directed to an aqueous coating composition comprising. Said aqueous coating composition can comprise:
A) a polymer dissolved or dispersed in water, said polymer comprises one or more crosslinkable functional groups;
B) a polytrimethylene ether diol having a Mn (number average molecular weight) in a range of from 500 to 10,000; and
C) a crosslinking agent having one or more crosslinking functional groups;
wherein said aqueous coating composition comprises in a range of from 10% to 80% of water, percentage based on total weight of the aqueous coating composition.

The aqueous coating composition can comprise 10% to 80% of water in one embodiment, 10% to 60% of water in another embodiment, 10% to 50% of water in yet another embodiment, 10% to 40% of water in yet another embodiment, 10% to 40% of water in yet another embodiment, 10% to 30% of water in yet another embodiment.

In further embodiment, the aqueous coating composition can contain:
(A) in a range of from 10% to 80% by weight in one example, 20% to 70% by weight in another example, of said polymer;
(B) in a range of from 1% to 30% by weight in one example, 1% to 20% by weight in another example, of the polytrimethylene ether diol; and
(C) in a range of from 10% to 50% by weight in one example and 10% to 45% by weight in another example of the crosslinking agent;
all weight percentages are based on the total weight of the binder composition, wherein the aqueous coating composition can comprise in a range of from 10% to 80% of water, percentage based on total weight of the aqueous coating composition

The polymer that is suitable for this invention can include acrylic polymer, hydroxyl polyester, oligomer, latex, polyurethane dispersion (PUD), or a combination thereof.

The acrylic polymer suitable for this invention can have a weight average molecular weight (Mw) of about 2,000 to 100,000, a glass transition temperature (Tg) in a range of from −75° C. to 80° C., and can contain functional groups or pendant moieties that are reactive with isocyanate or other crosslinking functional groups, such as, for example, hydroxyl, amino, amide, glycidyl, silane and carboxyl groups. The Tg of the acrylic polymer can be measured experimentally or calculated according to the Fox Equation. The acrylic polymer can be straight chain polymer, branched polymer, block copolymer, or graft polymer. Typical example of useful acrylic polymers can be polymerized from a plurality of monomers, such as acrylates, methacrylates, derivatives of acrylates or methacrylates, or a combination thereof.

Suitable monomers can include linear alkyl (meth)acrylates having 1 to 20 carbon atoms in the alkyl group, cyclic or branched alkyl (meth)acrylates having 3 to 20 carbon atoms in the alkyl group, including isobornyl (meth)acrylate, styrene, alpha methyl styrene, vinyl toluene, (meth)acrylonitrile, (meth)acryl amides and monomers that provide crosslinkable functional groups, such as, hydroxy alkyl (meth)acrylates having 1 to 4 carbon atoms in the alkyl group, glycidyl (meth)acrylate, amino alkyl (meth)acrylates having 1 to 4 carbon atoms in the alkyl group, (meth)acrylic acid, and alkoxy silyl alkyl (meth)acrylates, such as, trimethoxysilylpropyl (meth)acrylate.

Suitable monomers can also include, for example, hydroxyalkyl esters of alpha,beta-olefinically unsaturated monocarboxylic acids with primary or secondary hydroxyl groups. These may, for example, comprise the hydroxyalkyl esters of acrylic acid, methacrylic acid, crotonic acid and/or isocrotonic acid. Suitable monomers can also include any other monomers that are reaction products of alpha,beta-unsaturated monocarboxylic acids with glycidyl esters of saturated monocarboxylic acids branched in alpha position, for example with glycidyl esters of saturated alpha-alkylalkanemonocarboxylic acids or alpha,alpha′-dialkylalkanemonocarboxylic acids. These can comprise the reaction products of (meth)acrylic acid with glycidyl esters of saturated alpha,alpha-dialkylalkanemonocarboxylic acids. These reaction products can be formed before, during or after copolymerization reaction of the acrylic polymer.

Suitable monomers can further include monomers that are reaction products of hydroxyalkyl (meth)acrylates with lactones. Hydroxyalkyl (meth)acrylates which can be used include, for example, those stated above. Examples of lactones can include gamma-butyrolactone, delta-valerolactone, epsilon-caprolactone, beta-hydroxy-beta-methyl-delta-valerolactone, lambda-laurolactone or a mixture thereof. The hydroxyl groups of the hydroxyalkyl esters can be modified with the lactone before, during or after the copolymerization reaction.

Suitable monomers can also include unsaturated monomers, such as, for example, allyl glycidyl ether, 3,4-epoxy-1-vinylcyclohexane, epoxycyclohexyl (meth)acrylate, vinyl glycidyl ether and glycidyl (meth)acrylate, or monomers that are free-radically polymerizable, olefinically unsaturated monomers which, apart from at least one olefinic double bond, do not contain additional functional groups. Such monomers include, for example, esters of olefinically unsaturated carboxylic acids with aliphatic monohydric branched or unbranched as well as cyclic alcohols with 1 to 20 carbon atoms. Examples of the unsaturated carboxylic acids can include acrylic acid, methacrylic acid, crotonic acid and isocrotonic acid. In one embodiment, esters of (meth)acrylic acid can be used. Examples of esters of (meth)acrylic acid can include methyl acrylate, ethyl acrylate, isopropyl acrylate, tert.-butyl acrylate, n-butyl acrylate, isobutyl acrylate, 2-ethylhexyl acrylate, lauryl acrylate, stearyl acrylate and the corresponding methacrylates. Examples of esters of (meth)acrylic acid with cyclic alcohols can include cyclohexyl acrylate, trimethylcyclohexyl acrylate, 4-tert.-butylcyclohexyl acrylate, isobornyl acrylate and the corresponding methacrylates.

Suitable monomers can also include unsaturated monomers that do not contain additional functional groups for example, vinyl ethers, such as, isobutyl vinyl ether and vinyl esters, such as, vinyl acetate, vinyl propionate, vinyl aromatic hydrocarbons. Examples of such monomers can include styrene, alpha-methylstyrene, chlorostyrenes, 2,5-dimethylstyrene, p-methoxystyrene, vinyl toluene. In one embodiment, styrene can be used.

Suitable monomers can also include small proportions of olefinically polyunsaturated monomers. These olefinically polyunsaturated monomers are monomers having at least 2 free-radically polymerizable double bonds per molecule. Examples of these olefinically polyunsaturated monomers can include divinylbenzene, 1,4-butanediol diacrylate, 1,6-hexanediol diacrylate, neopentyl glycol dimethacrylate, and glycerol dimethacrylate.

The acrylic polymer can contain (meth)acrylamides. Typical examples of such acrylic polymers can be polymerized from monomers including (meth)acrylamide. In one example, such acrylic polymer can be polymerized from (meth)acrylamide and alkyl (meth)acrylates, hydroxy alkyl (meth)acrylates, (meth)acrylic acid and one of the aforementioned olefinically unsaturated monomers.

The acrylic polymers suitable for this invention can generally be polymerized by free-radical copolymerization using conventional processes well known to those of ordinary skill in the art, for example, bulk, solution or bead polymerization, in particular by free-radical solution polymerization using free-radical initiators. The acrylic polymers with acidic groups can be neutralized or partially neutralized with a base, such as amines or ammonia.

Particularly, monomers having inherent low Tg properties can be suitable for deriving low Tg acrylic polymers when so desired. Examples of low Tg monomers include butyl acrylate (Tg about −54° C.), 2-ethylhexyl acrylate (Tg about −50° C.), ethyl acrylate (Tg about −24° C.), isobutyl acrylate (Tg about −24° C.), and 2-ethylhexyl methacrylate (Tg about −10° C.). Monomers having inherent high Tg properties can be suitable for deriving high Tg acrylic polymers when so desired. Examples of such high Tg monomers can include styrene (Tg: 100° C.), methyl methacrylate (MMA) (Tg: about 105° C.), isobornyl methacrylate (IBOMA) (Tg: about 165° C.), isobornyl acrylate (IBOA) (Tg: about 94° C.), cyclohexyl methacrylate (CHMA) (Tg: about 83° C.), and isobutyl methacrylate (IBMA) (Tg: about 55° C.). The abovementioned Tg values are derived from published literatures and are commonly accepted in the industry. Theoretical Tgs of the acrylic polymers can be predicted using the Fox equation based on Tgs of the monomers. Actual Tg's of the finished polymers can be measured by DSC (Differential Scanning Calorimetry, also available as ASTM D3418/E1356).

The polyester suitable for this invention can be linear polyesters having one or more crosslinkable functional groups and having a glass transition temperature (Tg) in a range of from −75° C. to 85° C. Typical suitable linear polyesters can have a hydroxyl number in a range of from 5 to 250. Typical suitable linear polyester can have a weight average molecular weight in a range of from 1,000 to 40,000. The weight average molecular weight can be in a range of from 1,000 to 40,000 in one embodiment, 1,000 to 20,000 in another embodiment, 1,000 to 10,000 in yet another embodiment. The polyesters may be saturated or unsaturated and optionally, may be modified. These polyesters can be the esterification product of one or more polyhydric alcohols, such as, alkylene diols and glycols; and carboxylic acids such as monocarboxylic acids, polycarboxylic acids or anhydrides thereof, such as, dicarboxylic and/or tricarboxylic acids or tricarboxylic acid anhydrides. The polyesters can have ionic groups, such as carboxylic groups or amine groups; and/or non-ionic groups, such as ethylene oxides, to impart water compatibility.

Examples of polyhydric alcohols can include triols and tetraols, such as, trimethylol propane, triethylol propane, trimethylol ethane, glycerine, and dihydric alcohols and diols that include ethylene glycol, propylene glycol, 1,3-propanediol, 1,3-butanediol, 1,4-butanediol, 1,5-pentanediol, 1,6-hexanediol, 2,2-dimethyl-1,3-propanediol, diethylene glycol, dipropylene glycol, 1,4-cyclohexane dimethanol, hydrogenated bisphenols A and F, Esterdiol 204 (Union Carbide) and highly functional polyols, such as, trimethylolethane, trimethylolpropane, and pentaerythritol. Polyhydric alcohols having carboxyl groups may be used, such as, dimethylol propionic acid (DMPA).

Typical carboxylic acids and anhydrides can include aliphatic or aromatic carboxylic acids and anhydrides thereof, such as, adipic acid, azelaic acid, sebacic acid, dimerized fatty acids, maleic acid, maleic anhydride, succinic acid, succinic anhydride, isophthalic acid, terephthalic acid, phthalic acid, phthalic anhydride, dimethyl terephthalic acid, naphthalene dicarboxylic acid, tetrahydro- and hexahydrophthalic anhydride, tetrachlorophthalic acid, terephthalic acid bisglycol ester, benzophenone dicarboxylic acid, trimellitic acid and trimellitic anhydride.

The polyester can also be highly branched copolyesters. The highly branched copolyester can have a hydroxyl number in a range of from 5 to 200 and can have a weight average molecular weight in a range of from 1,000 to 50,000. The weight average molecular weight can be in a range of from 1,000 to 50,000 in one embodiment, 1,000 to 40,000 in another embodiment, 1,500 to 40,000 in yet another embodiment, 1,500 to 30,000 in yet another embodiment, and 2,000 to 30,000 in further another embodiment. The highly branched copolyester can have one or more hydroxyl crosslinkable function groups.

The highly branched copolyester can be conventionally polymerized from a monomer mixture containing a dual functional monomer selected from the group consisting of a hydroxy carboxylic acid, a lactone of a hydroxy carboxylic acid and a combination thereof; and one or more hyper branching monomers.

Conventional methods for synthesizing polyesters are known to those of ordinary skill in the art. Examples of the conventional methods can include those described in U.S. Pat. No. 5,270,362 and U.S. Pat. No. 6,998,154.

The polyurethan dispersion (PUD) suitable for this invention can include water dilutable polyurethan dispersions such as those disclosed in U.S. Pat. No. 5,556,912.

In order to ensure sufficient water solubility, dispersibility or dilutability, the polymers can be modified in a suitable manner to render them hydrophilic. The polymers can be ionically or non-ionically modified as mentioned before. An anionic and/or non-ionic modification is preferred. An anionic modification can be obtained, for example, by incorporating carboxyl groups which are at least partially neutralized. A non-ionic modification may be obtained, for example, by incorporating ethylene oxides. Alternatively, the polymer can be first dissolved or dispersed in a water miscible organic solvent and then further dissolved or dispersed into water.

The polytrimethylene ether diol suitable for the aqueous coating composition of this invention can have a number average molecular weight (Mn) in the range of from 500 to 10,000, preferably 500 to 8,000, even preferably 500 to 4,000. The polytrimethylene ether diol can have a Tg of about −75° C., a polydispersity in the range of from 1.1 to 2.1 and a hydroxyl number in the range of from 20 to 200. Polytrimethylene ether diol is also known as polytrimethylene ether glycol, polyoxytrimethylene glycol, or 3G polyol.

Suitable polytrimethylene ether diol can be prepared by an acid-catalyzed polycondensation of 1,3-propanediol, such as described in U.S. Pat. Nos. 6,977,291 and 6,720,459. The polytrimethylene ether diol can also be prepared by a ring opening polymerization of a cyclic ether, oxetane, such as described in J. Polymer Sci., Polymer Chemistry Ed. 28, 449 to 444 (1985). The polycondensation of 1,3-propanediol is preferred over the use of oxetane since the diol is a less hazardous, stable, low cost, commercially available material and can be prepared by use of petro chemical feed-stocks or renewable resources.

A bio-route via fermentation of a renewable resource can be used to obtain bio-derived 1,3-propanediol. One example of renewable resources is corn since it is readily available and has a high rate of conversion to 1,3-propanediol and can be genetically modified to improve yields to the 1,3-propanediol. Examples of typical bio-route can include those described in U.S. Pat. No. 5,686,276, U.S. Pat. No. 5,633,362 and U.S. Pat. No. 5,821,092.

Copolymers of polytrimethylene ether diol also can be suitable for the aqueous coating composition of this invention. Examples of such suitable copolymers of polytrimethylene ether diol can be prepared by copolymerizing 1,3-propanediol with another diol, such as, ethane diol, hexane diol, 2-methyl-1,3-propanediol, 2,2-dimethyl-1,3-propanediol, trimethylol propane and pentaerythritol. In one example, the copolymers of polytrimethylene ether diol can be polymerized from monomers have 1,3-propanediol in a range of from 50% to 99%. In another example, the copolymers of polytrimethylene ether diol can be polymerized from monomers have 1,3-propanediol in a range of from 60% to 99%. In yet another example, the copolymers of polytrimethylene ether diol can be polymerized from monomers have 1,3-propanediol in a range of from 70% to 99%.

A blend of a high and a low molecular weight polytrimethylene ether diol can be used. In one example, the high molecular weight polytrimethylene ether diol can have an Mn in a range of from 1,000 to 4,000 and the low molecular weight polytrimethylene ether diol can have an Mn in a range of from 150 to 500. The average Mn of the blended polytrimethylene ether diol can be in a range of from 500 to 4,000. In another example, the high molecular weight polytrimethylene ether diol can have an Mn in a range of from 1,000 to 4,000 and the low molecular weight polytrimethylene ether diol can have an Mn in a range of from 150 to 500 and the average Mn of the blend can be in a range of from 500 to 3,000.

Blends of the polytrimethylene ether diol and other cycloaliphatic hydroxyl containing either branched or linear oligomers can be used. Such hydroxyl containing oligomers are known to those of ordinary skill in the art. Examples of such hydroxyl containing oligomers can include those disclosed by Barsotti, et al. in U.S. Pat. No. 6,221,494.

The aqueous coating composition can comprise one or more surfactants. One example of such surfactant can include Byk® 190 commercially from Byk-Chemie, Wallingford, Conn., USA, under respective registered trademark. When the aqueous coating composition comprises more than 10% of polytrimethylene ether diol, such surfactant is preferred. Alternatively, polytrimethylene ether diol can also be first dissolved in water miscible organic solvent and then diluted or dispersed in water.

The aqueous coating composition can comprise one or more crosslinking agents. The crosslinking agents that are suitable for this invention can include compounds having aforementioned crosslinking functional groups. Examples of such compounds can include organic polyisocyanates. Examples of organic polyisocyanates can include aliphatic polyisocyanates, cycloaliphatic polyisocyanates, aromatic polyisocyanates and isocyanate adducts.

Examples of suitable aliphatic, cycloaliphatic and aromatic polyisocyanates that can be used include the following: 2,4-toluene diisocyanate, 2,6-toluene diisocyanate (“TDI”), 4,4-diphenylmethane diisocyanate (“MDI”), 4,4′-dicyclohexyl methane diisocyanate (“H12MDI”), 3,3′-dimethyl-4,4′-biphenyl diisocyanate (“TODI”), 1,4-benzene diisocyanate, trans-cyclohexane-1,4-diisocyanate, 1,5-naphthalene diisocyanate (“NDI”), 1,6-hexamethylene diisocyanate (“HDI”), 4,6-xylene diisocyanate, isophorone diisocyanate, (“IPDI”), other aliphatic or cycloaliphatic di-, tri- or tetra-isocyanates, such as, 1,2-propylene diisocyanate, tetramethylene diisocyanate, 2,3-butylene diisocyanate, octamethylene diisocyanate, 2,2,4-trimethyl hexamethylene diisocyanate, dodecamethylene diisocyanate, omega-dipropyl ether diisocyanate, 1,3-cyclopentane diisocyanate, 1,2-cyclohexane diisocyanate, 1,4-cyclohexane diisocyanate, 4-methyl-1,3-diisocyanatocyclohexane, dicyclohexylmethane-4,4′-diisocyanate, 3,3′-dimethyl-dicyclohexylmethane 4,4′-diisocyanate, polyisocyanates having isocyanurate structural units, such as, the isocyanurate of hexamethylene diisocyanate and the isocyanurate of isophorone diisocyanate, the adduct of 2 molecules of a diisocyanate, such as, hexamethylene diisocyanate, uretidiones of hexamethylene diisocyanate, uretidiones of isophorone diisocyanate and a diol, such as, ethylene glycol, the adduct of 3 molecules of hexamethylene diisocyanate and 1 molecule of water, allophanates, trimers and biurets, for example, of hexamethylene diisocyanate, allophanates, trimers and biurets, for example, of isophorone diisocyanate and the isocyanurate of hexane diisocyanate. MDI, HDI, TDI and isophorone diisocyanate are preferred because of their commercial availability.

Tri-functional isocyanates also can be used, such as, triphenyl methane triisocyanate, 1,3,5-benzene triisocyanate, 2,4,6-toluene triisocyanate. Trimers of diisocyanates, such as, the trimer of hexamethylene diisocyanate, sold as Tolonate® HDT from Rhodia Corporation and the trimer of isophorone diisocyanate are also suitable.

An isocyanate functional adduct can be used, such as, an adduct of an aliphatic polyisocyanate and a polyol or an adduct of an aliphatic polyisocyanate and an amine. Also, any of the aforementioned polyisocyanates can be used with a polyol to form an adduct. Polyols, such as, trimethylol alkanes, particularly, trimethylol propane or ethane can be used to form an adduct.

The aqueous coating composition can further comprise additional polymers or oligomers, catalysts, reactive diluent, solvents, pigments, ultraviolet light stabilizers, ultraviolet light absorbers, antioxidants, and conventional coating additives.

One example of the additional polymers or oligomers can include one or more latex such as acrylic latex or reactive oligomers known to those of ordinary skill in the art. Examples of latex can include acrylic latex such as those disclosed in U.S. Pat. No. 6,204,319.

The catalysts can be included to reduce curing time and to allow curing of the aqueous coating composition at ambient temperatures. The ambient temperatures are typically referred to as temperatures in a range of from 18° C. to 35° C. Typical catalysts can include dibutyl tin dilaurate, dibutyl tin diacetate, dibutyl tin dichloride, dibutyl tin dibromide, triphenyl boron, tetraisopropyl titanate, triethanolamine titanate chelate, dibutyl tin dioxide, dibutyl tin dioctoate, tin octoate, aluminum titanate, aluminum chelates, zirconium chelate, hydrocarbon phosphonium halides, such as, ethyl triphenyl phosphonium iodide and other such phosphonium salts, and other catalysts or mixtures thereof known to those of ordinary skill in the art.

The aqueous coating composition can contain organic solvents conventionally used in coating compositions. The organic solvents can originate from the preparation of the polymers or other aforementioned components, or can be added separately. Examples of suitable solvents can include monohydric or polyhydric alcohols, such as propanol, butanol, hexanol, butoxy ethanol, propoxy ethanol, sec-butanol, propoxy propanol, t-butoxy propanol, t-butanol; glycol ethers or esters, for example diethylene glycol dialkyl ether, dipropylene glycol dialkyl ether, ethoxypropanol, butyl glycol; glycols, for example ethylene glycol, propylene glycol, N-methyl pyrrolidone and ketones, e.g. methyl ethyl ketone, acetone, cyclohexanone; aromatic or aliphatic hydrocarbons, for example toluene, xylene, or straight-chain or branched aliphatic C6-C12 hydrocarbons. Some further examples of suitable organic solvents can include tributyl phosphate, mineral spirits, and pine oil. Some organic solvents that are immiscible with water can also be used in the coating composition of this invention, for example, as a defoamer. It is preferred to use water-miscible solvents.

Water can be used in this invention as a solvent or a reducer to modulate viscosity suitable for desired coating application process such as spraying, brush or roller coating, etc., as known to those of ordinary skill in the art.

The aqueous coating composition can contain one or more pigments. The aqueous coating composition can be used as a basecoat or topcoat, such as a colored topcoat. Conventional inorganic and organic colored pigments, metallic flakes and powders, such as, aluminum flake and aluminum powders; special effects pigments, such as, coated mica flakes, coated aluminum flakes colored pigments, or a combination thereof can be used. Transparent pigments such as silica can also be used.

The aqueous coating composition can also comprise one or more ultraviolet light stabilizers such as ultraviolet light absorbers, screeners, quenchers, and hindered amine light stabilizers, in effective amounts determined suitable by those of ordinary skill in the art.

The aqueous coating composition can also comprise one or more antioxidants and other conventional coating additives. Examples of such additives can include wetting agents, leveling and flow control agents; rheological control agents, such as highly disperse silica, fumed silica or polymeric urea compounds; thickeners, such as partially crosslinked polycarboxylic acid or polyurethanes; and antifoaming agents (also referred to as defoamer). The additives are used in conventional amounts familiar to those of ordinary skill in the art.

The aqueous coating compositions according to the invention can further contain reactive low molecular weight compounds as reactive diluents that are capable of reacting with the crosslinking agent. For example, low molecular weight polyhydroxyl compounds, such as ethylene glycol can be used.

Depending upon the type of crosslinking agent, the aqueous coating composition of this invention can be formulated as one-pack (1K) or two-pack (2K) coating composition. If polyisocyanates with free isocyanate groups are used as the crosslinking agent, the aqueous coating composition can be formulated as a two-pack coating composition in that the crosslinking agent is mixed with other components of the aqueous coating composition only shortly before coating application. If blocked polyisocyanates are, for example, used as the crosslinking agent, the aqueous coating compositions can be formulated as a one-pack (1K) coating composition. The aqueous coating composition can be further adjusted to spray viscosity with water before being applied as determined by those of ordinary skill in the art.

In a typical two-pack coating composition comprising two packages, the two packages are mixed together shortly before application. The first package typically can contain the acrylic polymer, the polyesters, the polytrimethylene ether diol and pigments, and water. The pigments can be dispersed in the first package using conventional dispersing techniques, for example, ball milling, sand milling, and attritor grinding. The second package can contain the crosslinking agent, such as, a polyisocyanate crosslinking agent, and water.

The aqueous coating composition can be suitable for vehicle and industrial coating and can be applied by conventional coating techniques. In the context of vehicle coating, the aqueous coating composition can be used both for automotive original equipment manufacturing (OEM) coating and for repairing or refinishing coatings of automotive body or an automotive body part. The aqueous coating composition can be formulated as a 2K or 1K refinish coating composition. Curing of the aqueous coating composition can be accomplished at ambient temperatures, such as temperatures in a range of from 18° C. to 35° C., or at elevated temperatures, such as at temperatures in a range of from 35° C. to 150° C. Typical curing temperatures of 20° C. to 80° C., in particular of 20° C. to 60° C., can be used for vehicle repair or refinish coatings.

The aqueous coating composition can be a polyurethane coating composition when the aqueous coating composition comprises aforementioned isocyanates and polymers having hydroxyl functional groups, such as hydroxyl-acrylic polymer, hydroxyl-polyester, or a combination thereof.

The use of polytrimethylene ether diol in coating compositions has been described in U.S. Pat. Nos. 6,875,514 and 7,169,475. However, those coating compositions are organic solvent based that typically have only trace amount of or no water. Polytrimethylene ether diol is known to have tendency to associate more with organic solvents. In fact, one method of purification is to use water to wash polytrimethylene ether diols to remove water soluble impurities and concentrate polytrimethylene ether diols in organic solvents (as described in U.S. Pat. No. 7,388,115). Therefore, no aqueous coating composition is currently available to comprise polytrimethylene ether diols and more than 10% of water. The Applicants unexpectedly discovered that when polytrimethylene ether diol is mixed with water soluble or dispersible polymers and crosslinking agent, a stable coating composition having more than 10% of water can be produced.

The Applicants further unexpectedly discovered that the aqueous coating composition comprising the polytrimethylene ether diols can have shortened drying time and increased coating film flexibility comparing to other known glycol or polyols, such as polypropylene glycol.

This invention is further directed to a process for coating a substrate with the aqueous coating composition of this invention. The process can comprise the steps of:

a) providing an aqueous coating composition comprising:
A) a polymer dissolved or dispersed in water, said polymer comprises one or more crosslinkable functional groups;
B) a polytrimethylene ether diol having a Mn (number average molecular weight) in a range of from 500 to 10,000; and
C) a crosslinking agent having one or more crosslinking functional groups;
wherein said aqueous coating composition comprises in a range of from 10% to 80% of water, percentage based on total weight of the aqueous coating composition;

b) applying said aqueous coating composition over the substrate to form a layer of said aqueous coating composition thereon; and

c) curing said layer of the aqueous coating composition to form said coating layer.

The aqueous coating composition can be applied by conventional techniques, such as, spraying, electrostatic spraying, dipping, brushing, wet drawdown or flow coating. Typically, the aqueous coating composition can be applied over the substrate to form a layer of the aqueous coating composition and then cured to form a dry coating layer having a thickness of 20 to 300 microns in one example, 50 to 200 microns in another example, and 50 to 130 microns in yet another example. Typically, the layer of the aqueous coating composition can be cured at ambient temperatures or at elevated temperatures as mentioned before.

For spraying, water can be used to modulate viscosity of the aqueous coating composition.

This invention is further directed to an article coated with the aqueous coating composition or the process disclosed herein. The article can be a vehicle; electronic devices or appliances, such as TV sets, refrigerators, or computers; industrial equipments; pipes; structures, such as houses; tanks, such as gas or oil tanks; machines; amusement park equipments; concrete; woods; or any articles that are made from metals, plastics, composite materials, or a combination of the materials.

### Testing Procedures

Dry Film Thickness—test method ASTM D4138

Viscosity—can be measured using (1) Zahn Viscosity as determined using a #1 Zahn cup according to ASTM D 1084 Method D; (2) Gardner-Holdt Letter scale according to ASTM D1545; or (3) Brookfield viscometer; as specified.

Persoz Hardness Test—the change in film hardness of the coating was measured with respect to time after application by using a Persoz Hardness Tester Model No. 5854 [ASTM D4366] supplied by Byk-Mallinckrodt, Wallingford, Conn. The measurement is in second.

Tg (glass transition temperature) of a polymer is determined according to ASTM D-3418 (1988) or calculated according to the Fox Equation.

Molecular weight and hydroxyl number of the polytrimethylene ether diol are determined according to ASTM E222.

Molecular weights Mw and Mn and the polydispersity (Mw/Mn) of the acrylic polymer and other polymers are determined by GPC (Gel Permeation Chromatography) using polystyrene standards and tetrahydrofuran as the solvent.

Dry to touch time—Dry to touch time is determined by ASTM D1640.

Flexibility of coatings—Flexibility test can be done using Mandrel Bending test of attached organic coatings as described in ASTM D522 A. Flexibility of the coating can be shown as percent elongation in a range of from 2% (not flexible) to 30% (flexible).

Gloss is measured with a specular glossmeter available from Byk-Gardener, Geretsried, Germany.

In the following examples, all parts and percentages are on a weight basis unless otherwise indicated. “Mw” weight average molecular weight and “Mn” means number average molecular weight.

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### EXAMPLES

### Coating Compositions

Coating compositions were prepared according to Table 1. Polypropylene glycol was used as a control. For each coating composition, Part A and Part B were mixed to form a pot mix immediately before use. Appearance of each of the pot mixes was indicated in Table 1. Addition of the control polypropylene glycol resulted in low gloss appearance that is not desired. Addition of polytrimethylene ether diols in the aqueous coating composition of this invention resulted in high gloss appearance.

TABLE 1
Coating Compositions (weight in grams).

| | Comparative | Comparative | Example |
|---|---|---|---|
| | 1 | 2 | 1 |
| Part A: | | | |
| Polymer Mix in water ⁽¹⁾ | 60 | 50 | 50 |
| Polypropylene glycol ⁽²⁾ | 0 | 10 | 0 |
| Polytrimethylene ether diols ⁽³⁾ | 0 | 0 | 10 |
| Part B: | | | |
| Crosslinking Agent FG-572 ⁽⁴⁾ | 40 | 40 | 40 |

⁽¹⁾ Polymer mix is a waterborne coating mix comprising hydroxyl functional acrylic and polyester polymers, commercially available as Imron ® ZV-HG ™ from E. I. DuPont de Nemours and Company, Wilmington, DE, USA. The polymer mix contains 16% to 26% of water.
⁽²⁾ Polypropylene glycol has a molecular weight of 2000, available commercially as PPG2000 from Aldrich Chemical Company, Product No. 81380.
⁽³⁾ Polytrimethylene ether diols were prepared according to the process described in U.S. Pat. No. 6,875,514, col. 9, line 29 through col. 10, line 8. Number average molecular weight (Mn) was about 1,300-1,450 with hydroxyl number of 77.4-86.3.
⁽⁴⁾ FG-572 is a crosslinking activator comprising diisocyanates, available from E. I. DuPont de Nemours and Company, Wilmington, DE, USA.

### Coating Properties

The coating compositions were applied by wet drawdown on substrates. Each substrate was a steel plate that had been coated with high solid epoxy primer Corlar® 2.1-PR™) available from E. I. DuPont de Nemours and Company, Wilmington, Del., USA, under respective registered and unregistered trademarks. The coating compositions were wet drawdown onto the substrate over the dried primer layer forming a dry coating layer at about 4 mil (about 100 micron) in thickness.

Dry time of the coating layers was measured according to ASTM D1640. The flexibility test was done with 1 mil coating film using the Mandrel Bending test method. The values represent percent elongation.

Data on coating properties are shown in Table 2. The data indicated that the coating from the aqueous coating compositions of this invention had shortened drying time, high gloss and increased flexibility.

TABLE 2
Coating Properties.

| | Comparative | Comparative | Example |
|---|---|---|---|
| | 1 | 2 | 1 |
| Dry time (minutes) | 90 | 400 | 45 |
| 60° Gloss | 95 | 80 | 95 |
| Flexibility | 20% | 15% | 28% |
| Appearance | Glossy | Satin | Glossy |

1. An aqueous coating composition comprising:
A) a polymer dissolved or dispersed in water, said polymer comprises one or more crosslinkable functional groups;
B) a polytrimethylene ether diol having a Mn (number average molecular weight) in a range of from 500 to 10,000; and
C) a crosslinking agent having one or more crosslinking functional groups;
wherein said aqueous coating composition comprises in a range of from 10% to 80% of water, percentage based on total weight of the aqueous coating composition.

2. The aqueous coating composition of claim 1, wherein said polymer comprises one or more hydroxyl functional groups as the crosslinkable functional groups.

3. The aqueous coating composition of claim 2, wherein said polymer is a hydroxyl (meth)acrylic polymer, a hydroxyl polyester, a latex, or a combination thereof.

4. The aqueous coating composition of claim 3, wherein said hydroxyl polyester is selected from: one or more linear polyesters having hydroxyl functional groups; one or more branched copolyesters having hydroxyl functional groups; or a combination thereof.

5. The aqueous coating composition of claim 1, wherein the crosslinking agent comprises one or more organic polyisocyanates.

6. The aqueous coating composition of claim 5, wherein said one or more organic polyisocyanates are selected from the group consisting of aliphatic polyisocyanates, cycloaliphatic polyisocyanates, aromatic polyisocyanates, tri-functional isocyanates and isocyanate adducts.

7. The aqueous coating composition of claim 1, wherein the polytrimethylene ether diol has a Mn in a range of from 500 to 4,000, a Tg of about −75° C. and a hydroxyl number in a range of from 20 to 200.

8. The aqueous coating composition of claim 7, wherein the polytrimethylene ether dial is a blend of high and low molecular weight polytrimethylene ether dials wherein the high molecular weight polytrimethylene ether dial has an Mn in a range of from 1,000 to 4,000 and the low molecular weight polytrimethylene ether dial has an Mn in a range of from 150 to 500 and the average Mn of the blend is in a range of from 500 to 4,000.

9. The aqueous coating composition of claim 1, wherein the polytrimethylene ether diol is polymerized from bio-derived 1,3-propanediol.

10. The aqueous coating composition of claim 1 further comprising pigments, ultraviolet light stabilizers, ultraviolet light absorbers, antioxidants, hindered amine light stabilizers, leveling agents, rheological agents, thickeners, antifoaming agents, wetting agents, catalysts, or a combination thereof.

11. The aqueous coating composition of claim 1, wherein said aqueous coating composition is formulated as a 2K refinish coating composition.

12. An article coated with the aqueous coating composition of claim 1.

13. The article of claim 12, wherein said article is an automotive body or an automotive body part.

14. A process for coating a substrate to form a coating layer thereon, said process comprising the steps of;
a) providing an aqueous coating composition comprising:
A) a polymer dissolved or dispersed in water, said polymer comprises one or more crosslinkable functional groups;
B) a polytrimethylene ether diol having a Mn (number average molecular weight) in a range of from 500 to 10,000; and
C) a crosslinking agent having one or more crosslinking functional groups;
wherein said aqueous coating composition comprises in a range of from 10% to 80% of water, percentage based on total weight of the aqueous coating composition;
b) applying said aqueous coating composition over the substrate to form a layer of said aqueous coating composition thereon; and
c) curing said layer of the aqueous coating composition to form said coating layer.

15. The process of claim 14, wherein said polymer comprises one or more hydroxyl functional groups as the crosslinkable functional groups.

16. The process of claim 15, wherein said polymer is a hydroxyl acrylic polymer, a hydroxyl polyester, a latex, or a combination thereof.

17. The process of claim 16, wherein said hydroxyl polyester is selected from: one or more linear polyesters having hydroxyl functional groups; one or more branched copolyesters having hydroxyl functional groups; or a combination thereof.

18. The process of claim 14, wherein the crosslinking agent comprises one or more organic polyisocyanates.

19. The process of claim 18, wherein said one or more organic polyisocyanates are selected from the group consisting of aliphatic polyisocyanates, cycloaliphatic polyisocyanates, aromatic polyisocyanates, tri-functional isocyanates and isocyanate adducts.

20. The process of claim 14, wherein said aqueous coating composition further comprises pigments, ultraviolet light stabilizers, ultraviolet light absorbers, antioxidants, hindered amine light stabilizers, leveling agents, rheological agents, thickeners, antifoaming agents, wetting agents, catalysts, or a combination thereof.

21. The process of claim 14, wherein said aqueous coating composition is formulated as a 2K refinish coating composition.

22. The process of claim 14, wherein said substrate is an automotive body or an automotive body part.

23. An article coated with the process of claim 14.

24. The article of claim 23, wherein said article is an automotive body or an automotive body part.
